(19) United States
(12) Patent Application Publication
(10) Pub. No.: US 2015/0146012 A1
(43) Pub. Date: May 28, 2015

(54) VIDEO PRESENTATION QUALITY DISPLAY IN A WIRELESS COMMUNICATION DEVICE

(71) Applicant: SPRINT COMMUNICATIONS COMPANY L.P., Overland Park, KS (US)

(72) Inventors: Trevor Daniel Shipley, Olathe, KS (US); Benjamin P. Blinn, Leawood, KS (US); Jason W. Rincker, Overland Park, KS (US)

(73) Assignee: SPRINT COMMUNICATIONS COMPANY L.P., Overland Park, KS (US)

(21) Appl. No.: 14/092,406

(22) Filed: Nov. 27, 2013

(51) Int. Cl. H04N 17/02; H04N 17/04

(52) U.S. Cl. CPC H04N 17/02; H04N 17/045
USPC 348/177

(57) ABSTRACT

A wireless communication device displays video presentation quality for an identified video. The wireless communication device processes its device configuration data and wireless network performance data to estimate presentation quality of the identified video. The wireless communication device displays a video presentation activator that graphically indicates the estimated presentation quality for the identified video. If the video presentation activator is activated by a user, then the wireless communication device initiates a download and display of the identified video.

### TECHNICAL BACKGROUND

User perception of video presentation quality may be impacted by delay in starting the video presentation, skipping or pausing during video presentation, or visual graininess. The quality of the user's video viewing experience may be affected by techniques such as transcoding, buffering, and scaling.

Wireless communication poses challenges to video presentation quality. A wireless network link may have limited bandwidth that may also be reduced by noise, congestion, and distance or obstruction between the wireless device and its network access point. A cellular service provider network may further impact video presentation quality either accidentally with backhaul congestion or intentionally by throttling or transcoding. As such a conventional indicator of wireless link health, such as signal strength bars, might not accurately forecast video presentation quality.

Hand held devices are especially challenging to video presentation quality. Limited screen resolution makes the delivery of needlessly high quality video potentially wasteful of network transmission time or of device processing time spent downscaling. Although a remote server might offer different encodings of a video, wide variations in hand held screen resolutions diminish the likelihood that a video is available encoded in a device's native resolution. Any of these factors that impact video presentation quality may make it difficult for a user to predict how will be the user experience before actually playing a chosen video.

### TECHNICAL OVERVIEW

A wireless communication device displays video presentation quality for an identified video. The wireless communication device processes its device configuration data and wireless network performance data to estimate presentation quality of the identified video. The wireless communication device displays a video presentation activator that graphically indicates the estimated presentation quality for the identified video. If the video presentation activator is activated by a user, then the wireless communication device initiates a download and display of the identified video.

### BRIEF DESCRIPTION OF THE DRAWINGS

FIG. 1 illustrates a wireless communication device that displays video presentation quality.

FIG. 2 illustrates the behavior of a wireless communication device that displays video presentation quality.

FIG. 3 illustrates a wireless communication system that displays video presentation quality.

FIG. 4 illustrates a wireless communication device that displays video presentation quality.

FIG. 5 illustrates video presentation activators.

FIG. 6 illustrates video presentation activators.

FIG. 7 illustrates a video presentation activator.

FIG. 8 illustrates a wireless communication device that displays video presentation quality.

### DETAILED DESCRIPTION

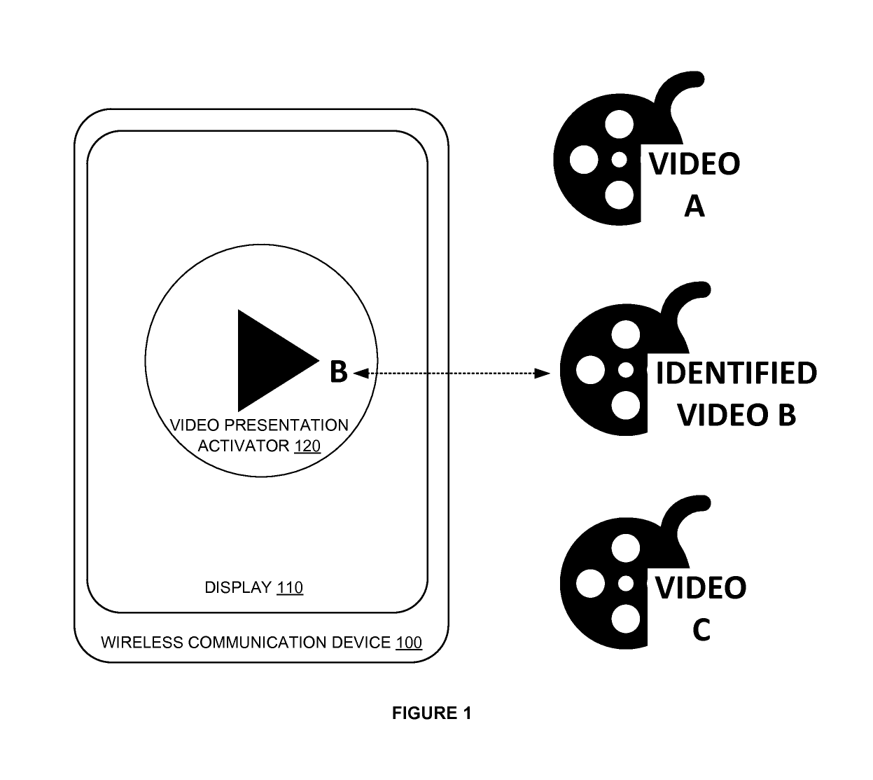

FIG. 1 illustrates wireless communication device 100 that displays video presentation quality information. Device 100 may be a smart phone, a tablet, a personal computer, a game console, a hand-held or wearable console, or other software processing device that has a wireless transceiver. Device 100 obtains presentation quality information of parameters that can affect the quality of the presentation of an identified video, such as available wireless network bandwidth and video bit rate. Device 100 may directly gather presentation quality information. Over a wireless network device 100 may receive presentation quality information that is maintained by a status service or by the network itself.

On display 110 wireless communication device 100 shows video presentation activator 120, which may be a graphical user interface widget such as a button. User activation of video presentation activator 120 begins a presentation of the identified video. This example includes videos A-C, which might not already reside on device 100. As illustrated by the dashed line, identified video B is the video identified by device 100. The presentation quality information of identified video B may include the capabilities of device 100, the condition of the wireless network and any other transport infrastructure involved, as well as the encoding of the video.

The visual appearance of video presentation activator 120 is rendered to indicate the presentation quality information obtained for the identified video. If the presentation quality of identified video B is likely to be low, video presentation activator 120 is rendered with one visual appearance. If the presentation quality of identified video B is likely to be high, video presentation activator 120 is rendered with another visual appearance that differs in a way that meaningfully indicates better quality. The user may regard the visually indicated presentation quality information as a forecast of the user experience to be expected during presentation of the identified video.

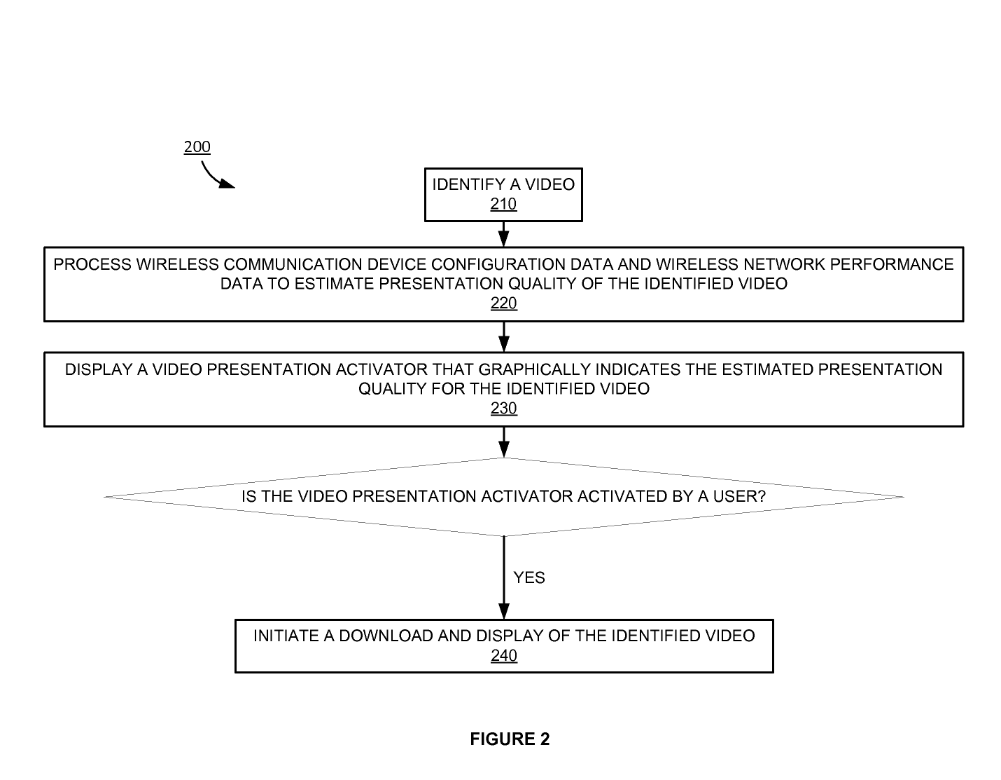

The states and operations involved with displaying video presentation quality on wireless communication device 100 are illustrated as behaviors 200 in FIG. 2. Device 100 begins by identifying (210) a video that is offered to the user for presentation. Device 100 processes (220) wireless communication device configuration data and wireless network performance data to estimate presentation quality of the identified video. Device 100 displays (230) a video presentation activator that graphically indicates the estimated presentation quality for the identified video. If the video presentation activator is activated by a user, then device 100 initiates (240) a download and display of the identified video.

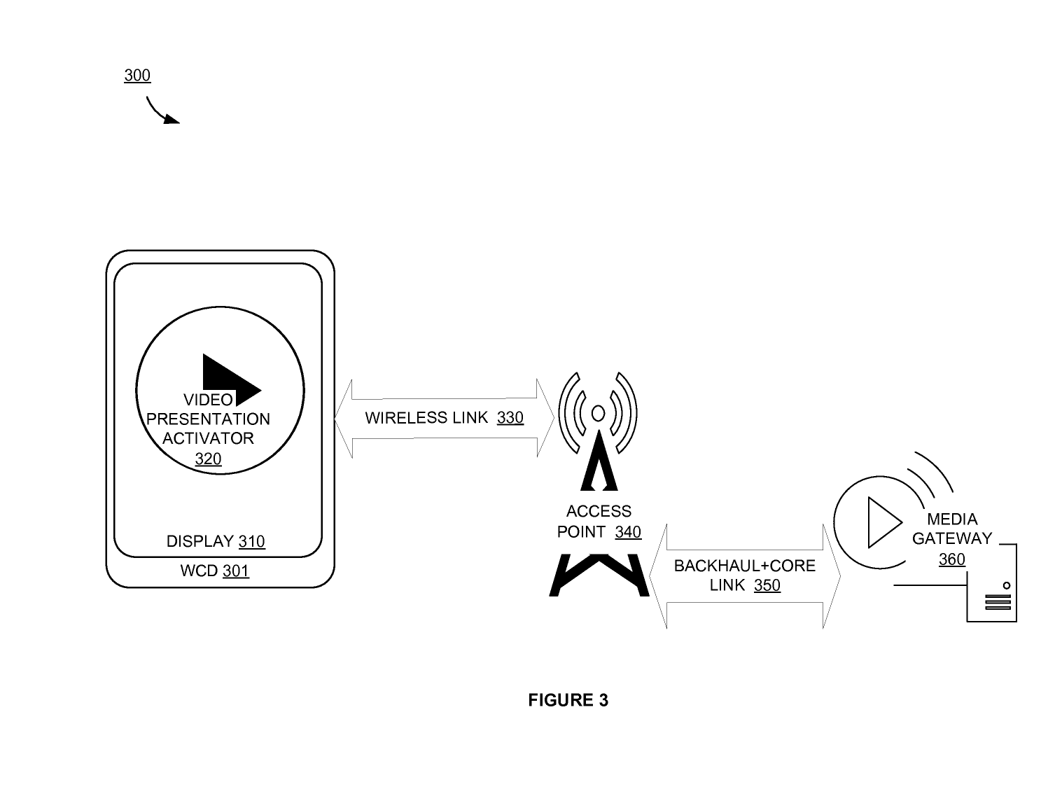

FIG. 3 illustrates wireless communication system 300, which includes wireless communication device 301 as an example of wireless communication device 100. In this example device 301 identifies a video to be retrieved through media gateway 360. Although the original source of the identified video is not shown in FIG. 3, the identified video may reside on a remote file server or originate on a remote stream server. Any request by device 301 for the contents or metadata of the identified video is directed to media gateway 360. Media gateway 360 may cache content and may transcode videos according to the limitations of device 301 and the limitations of any networks between device 301 and mediate gateway 360.

Media gateway 360 may perform video transcoding in a variety of ways. If the resolution of the identified video exceeds the screen resolution of device 301, then media gateway 360 may downscale the video. If the identified video originates in a format that is incompatible with wireless communication device 301, then media gateway 360 may transcode the video into a compatible format. If the frame rate is too high for device 301 to process, then media gateway 360 may reduce the frame rate. If a static or dynamic limitation on available downstream bandwidth does not accommodate the bit rate needed for the original encoding of the identified video, then media gateway 360 may reduce the frame rate or the pixel resolution of the video. When device 301 requests metadata or other presentation quality information of an identified video, media gateway 360 responds with information that reflects any caching or transcoding involved.

Wireless communication device 301 may obtain video presentation quality information that regards a variety of components in wireless communication system 300. Device 301 may gather data about the quality of wireless link 330 that connects device 301 to access point 340. Device 301 may measure signal strength and packet loss. Device 301 may also monitor the conditions and resources of access point 340, such as traffic and the availability of access slots. Alternatively device 301 may passively receive reports of such information from the access network. A report may include network weather information such as the level of congestion on link 350 that spans the backhaul and core network between access point 340 and media gateway 360. Device 301 uses the visual appearance of video presentation activator 320, as rendered on display 310, to indicate a summary of whatever presentation quality information is obtained for the identified video.

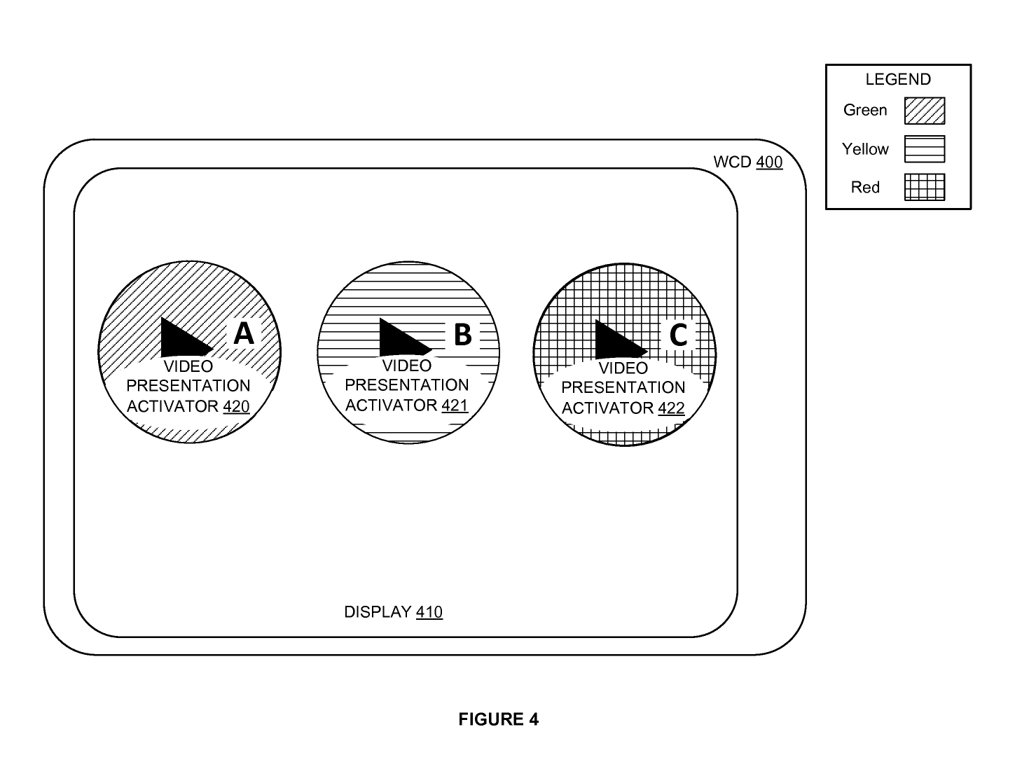

FIG. 4 illustrates wireless communication device 400 as an example of wireless communication device 100. In this example display 410 shows multiple video presentation activators 420-422 corresponding to videos A-C. Video presentation activators 420-422 are colored to indicate the presentation quality of corresponding videos A-C. Video A is encoded at a resolution that is well suited for display 410 and at a bit rate that does not stress the access network connected to device 400. Because of these conditions the presentation quality information for video A indicates a high quality presentation, and so video presentation activator 420 is colored green. The user may play video A with confidence that there will not be skips, pauses, or graininess during presentation. Video B also will not pause or skip, but is encoded at a low frame rate or resolution. Hence the presentation quality information for video B is moderate, and so video presentation activator 421 is colored yellow. Video C is encoded at a very high quality. However the bandwidth required to carry video C exceeds the available bandwidth of the wireless access network, such that presentation of video C on device 400 will be plagued by buffering pauses. As such video presentation activator 422 is colored red to indicate low presentation quality.

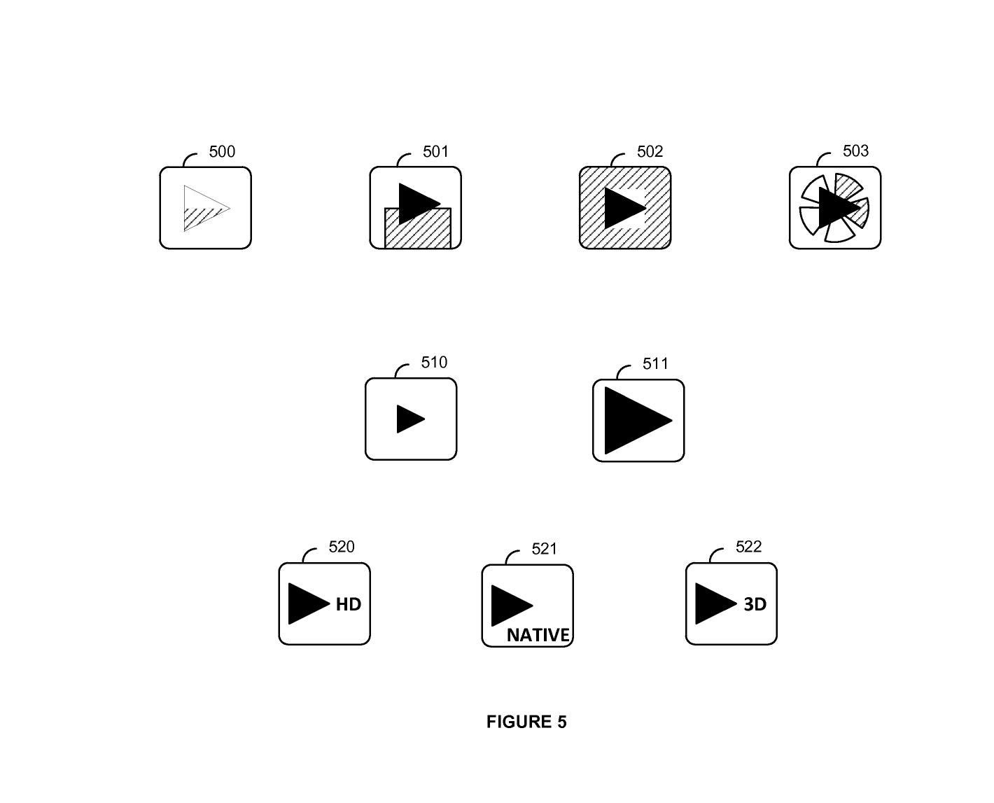

A wireless communication device has flexibility as to how it decorates a video presentation activator to reveal video presentation quality information. Some alternatives are illustrated in FIG. 5. Video presentation activators 500 and 501 show a lightly shaded portion that fills vertically according to a quality level given in the video presentation quality information. Video presentation activator 502 shows the fill level as a lightly shaded border that expands inward as the quality level rises to indicate better video presentation quality. Video presentation activator 503 shows the quality level in discrete geometric increments akin to signal bars, but arranged radially. As shown in video presentation activators 510 and 511 a pictorial image within the video presentation activator may be resized according to the quality level given in the video presentation quality information. Video presentation activator 510 indicates low quality, and video presentation activator 511 indicates high quality. Video presentation activators 520-522 indicate that some quality threshold is achieved. For example video presentation activator 520 indicates that the identified video will play at a resolution and frame rate that qualifies as high definition video, such as at least 720p or 1080i. Video presentation activator 521 may indicate that the identified video is encoded at the native screen resolution of the wireless communication device and will be played without up scaling or down scaling distortion. Video presentation activator 522 indicates that there is sufficient available network and device processor bandwidth to play the identified video as a three dimensional video without falling back to two dimensional delivery or presentation.

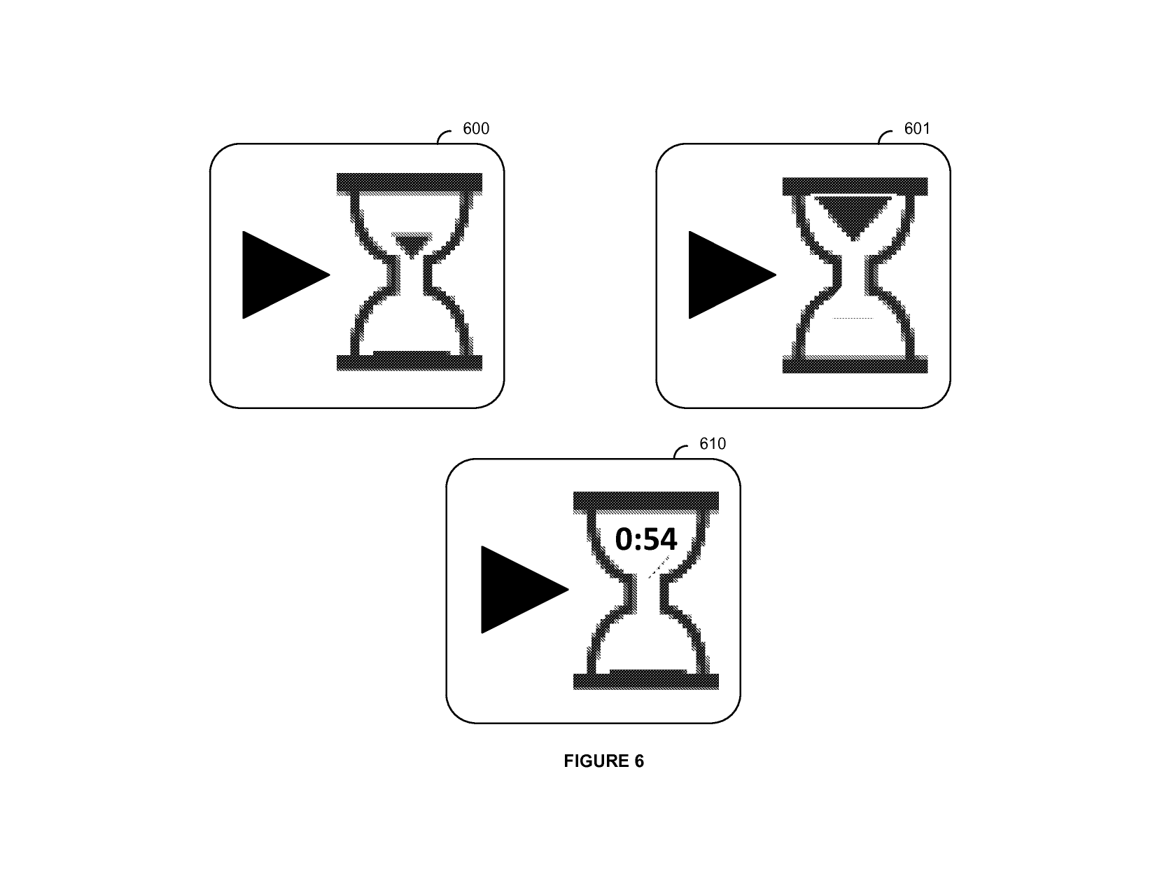

Because of the limited bandwidth of access networks, a wireless communication device typically buffers video content before presentation begins. The user observes this initial buffering as a delay between when he requested that the presentation begin and when the presentation actually begins. An estimate of this initial delay may be included in the video presentation quality information, as illustrated in FIG. 6. Video presentation activators 600-601 show a triangle typical of a play button and an hourglass. Within the top half of each hourglass is an inverted triangle that graphically indicates how long the initial delay will be before the video presentation can begin. For example if the access network has ample available bandwidth to quickly fill the download buffer of the wireless communication device, then the initial delay will be short, and so the inverted triangle is small within video presentation activator 600. However if the video bit rate is high or the available network bandwidth is low, then the download buffer will be slow to fill, and so video presentation activator 601 has a big inverted triangle to indicate a long initial delay. Video presentation activator 610 illustrates that the initial delay may be indicated textually, perhaps as minutes and seconds.

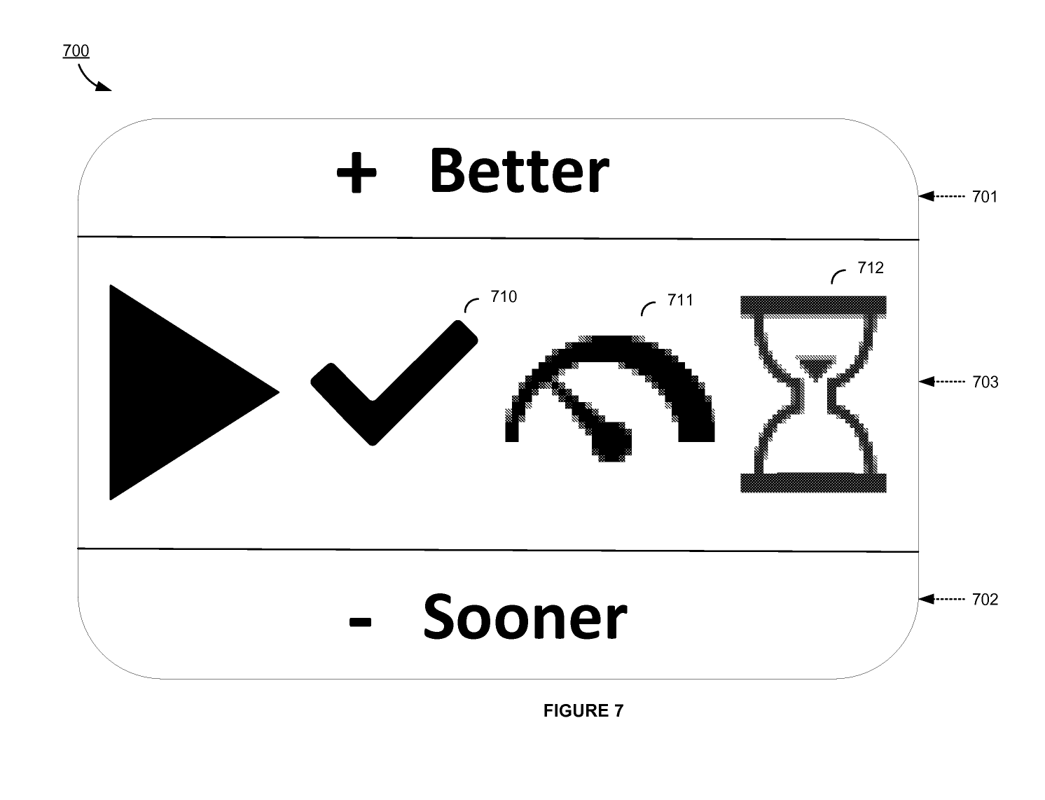

FIG. 7 illustrates compound video presentation activator 700 as an example capable of showing presentation quality information for multiple available encodings of an identified video. Compound video presentation activator 700 is visibly divided into three horizontal bands 701-703. Assuming that compound video presentation activator 700 is displayed on a touch screen, either of horizontal bands 701-702 may be pressed to iterate through the available encodings of the video. When either of horizontal bands 701-702 is pressed, a particular video encoding is selected, and the presentation quality information of the selected encoding is shown in horizontal band 703.

Horizontal band 703 may show presentation quality details such as checkmark 710 to indicate that the wireless communication device and network have the capacity to play the selected encoding without skipping or pausing during the presentation. Picture quality meter 711 may indicate the resolution and frame rate of the selected encoding such that a left-pointing needle denotes low quality and a right-pointing needle denotes high quality. The size of the triangle within the top half of hourglass 712 indicates the relative initial buffering delay before presentation of the selected encoding can begin. If the picture quality of the currently selected encoding is inadequate, the user may select the next higher quality video encoding by pressing horizontal band 701 at the expense of a longer initial buffering delay. If the initial buffering delay is too long, the user may select the next faster buffering encoding by pressing horizontal band 702 at the expense of lower picture quality. When the desired video encoding is selected, the user may press horizontal band 703 to start the presentation.

Compound video presentation activator 700 demonstrates one way to expose the user to multiple encodings of a video. Other forms of compound video presentation activators include showing the presentation quality information for the available encodings in corresponding activators that appear as items listed in a combobox or menu. Alternatively the presentation quality information of each available encoding could be appear in individual buttons shown together, such as a group of push buttons or radio buttons.

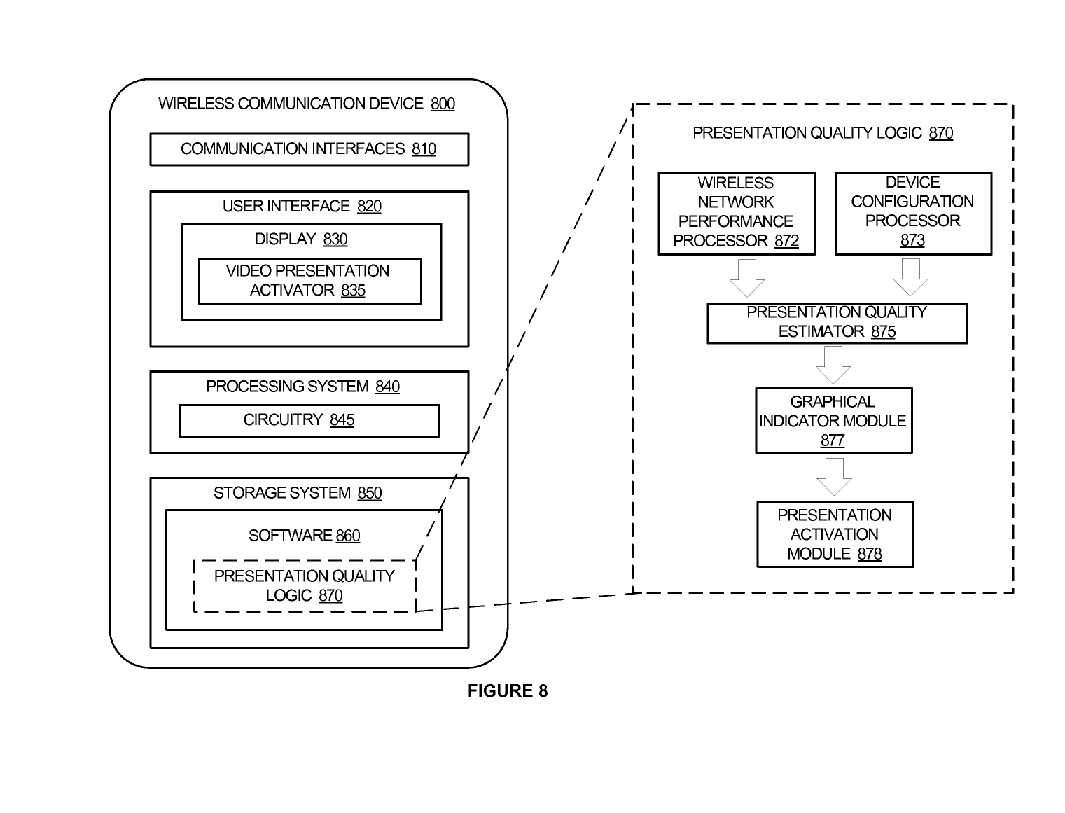

FIG. 8 illustrates wireless communication device 800, which is an example internal configuration of other wireless communication devices 100, 301, and 400, although these other devices could use alternative configurations. Wireless communication device 800 comprises wireless communication interfaces 810, user interface 820, and processing system 840. Processing system 840 is linked to wireless communication interfaces 810 and user interface 820. Processing system 840 includes processing circuitry 845 which is connected to storage system 850 that stores operating software 860. Wireless communication device 800 may include other well-known components such as a battery and enclosure that are not shown for clarity. Wireless communication device 800 may be a telephone, computer, mobile Internet appliance, game console, or some other wireless communication apparatus—including combinations thereof.

Wireless communication interfaces 810 comprises RF communication circuitry and an antenna. The RF communication circuitry typically includes an amplifier, filter, RF modulator, and signal processing circuitry. Wireless communication interfaces 810 may also include a memory device, software, processing circuitry, or some other communication device. Wireless communication interfaces 810 use various protocols, such as CDMA, EVDO, WIMAX, GSM, LTE, Wi-Fi, HSPA, Bluetooth, 1xRTT or some other wireless communication format.

User interface 820 comprises components that interact with a user to receive user inputs and to present media and/or information. User interface 820 includes display screen 830 and may also include a speaker, microphone, buttons, lights, touch screen, touch pad, scroll wheel, communication port, or some other user input/output apparatus—including combinations thereof.

Processing circuitry 845 comprises microprocessor and other circuitry that retrieves and executes operating software 860 from storage system 850. Storage system 850 comprises a non-transitory storage medium, such as a disk drive, flash drive, data storage circuitry, or some other memory apparatus. Processing circuitry 845 is typically mounted on a circuit board that may also hold storage system 850 and portions of communication interfaces 810 and user interface 820. Operating software 860 comprises computer programs, firmware, or some other form of machine-readable processing instructions. Operating software 860 includes presentation quality logic 870, which is an implementation of the states and operations illustrated in FIG. 2 tailored according to desired features. Operating software 860 may also include an operating system, utilities, drivers, network interfaces, applications, or some other type of software. When executed by processing circuitry 845, operating software 860 directs processing system 840 to operate wireless communication device 800 as described herein and in accordance with presentation quality logic 870.

The implementation of presentation quality logic 870 may be an aggregation of modules such as those shown in FIG. 8. Wireless network performance processor 872 may provide status and measurements based on information from communication interfaces 810 and otherwise mediate between communication interfaces 810 and presentation quality estimator 875. Presentation quality estimator 875 can identify a video, obtain presentation quality information of the video, and deliver the presentation quality information to graphical indicator module 877. Graphical indicator module 877 decides what visual elements are included in video presentation activator 835, how to decorate those visual elements according to the presentation quality information, and drives display screen 830 to accomplish rendering. User activation of video presentation activator 835 causes presentation activation module 878 to initiate download and presentation of the video. Implementations of presentation quality logic 870 have flexibility as to how many logic modules are present and how responsibilities are distributed amongst the modules.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method of operating a wireless communication device that estimates a video presentation quality comprising:
identifying a video;
processing wireless communication device configuration data, which includes information about components in the wireless communication device, and wireless network performance data to estimate the presentation quality of the identified video;
displaying a video presentation activator that graphically indicates presentation quality information, wherein the presentation quality information comprises the wireless communication device's capacity to play the video, a wireless communication network's capacity to play the video, an estimated picture quality, and an estimated initial buffer delay and wherein a user has an option to play the video, select a next higher video quality, or select a next faster buffering encoding; and
initiating a download and display of the identified video based on the option selected by the user.

2. The method of claim 1 wherein displaying the video presentation activator comprises indicating that presentation of the identified video occurs at a resolution that comprises a native screen resolution of the wireless communication device.

3. The method of claim 1 wherein displaying the video presentation activator comprises rendering with at least one of a color, a luminosity, and a fill pattern to indicate the presentation quality information.

4. The method of claim 1 wherein displaying the video presentation activator comprises rendering with a graphical fill level to indicate the presentation quality information.

5. The method of claim 1 wherein the presentation information further comprises a resolution that comprises high definition.

6. The method of claim 1 wherein the estimated initial buffer delay comprises a duration of delay between activating the video presentation activator and presentation of the identified video.

7. The method of claim 1 wherein the presentation information further comprises indicating 3D video.

8. The method of claim 1 wherein the presentation quality information comprises information for each of multiple encodings of the identified video, and displaying the video presentation activator comprises for at least one encoding of the identified video displaying a corresponding activator and rendering the visual appearance of the corresponding activator to indicate the presentation quality information for the video encoding.

9. The method of claim 8 wherein displaying the video presentation activator comprises indicating that the video presentation will occur without skipping or pausing after presentation of the identified video begins.

10. The method of claim 1 wherein processing wireless network performance data comprises the wireless communication device monitoring the performance and resources of a wireless access network.

11. A wireless communication device that estimates video presentation quality comprising:
a display;
a processing system configured to identify a video, process wireless communication device configuration data, which includes information about components in the wireless communication device, and wireless network performance data to estimate presentation quality of the identified video, display a video presentation activator that graphically indicates the estimated presentation quality for the identified video, and if the video presentation activator is activated by a user, then initiate a download and display of the identified video.

12. The wireless communication device of claim 11 wherein the processing system is configured to display the video presentation activator comprising indicating that presentation of the identified video occurs at a resolution that comprises the native screen resolution of the wireless communication device.

13. The wireless communication device of claim 11 wherein the processing system is configured to display the video presentation activator comprising rendering with at least one of a color, a luminosity, and a fill pattern to indicate the presentation quality information.

14. The wireless communication device of claim 11 wherein the processing system is configured to display the video presentation activator comprising rendering with a graphical fill level to indicate the presentation quality information.

15. The wireless communication device of claim 11 wherein the processing system is configured to display the video presentation activator comprising indicating that presentation of the identified video occurs at a resolution that comprises high definition.

16. The wireless communication device of claim 11 wherein the presentation quality information comprises a duration of delay between activating the video presentation activator and presentation of the identified video.

17. The wireless communication device of claim 11 wherein the processing system is configured to display the video presentation activator comprising indicating 3D video.

18. The wireless communication device of claim 11 wherein the presentation quality information comprises information for each of multiple encodings of the identified video, and the processing system is configured to display the video presentation activator comprising for at least one encoding of the identified video displaying a corresponding activator and rendering the visual appearance of the corresponding activator to indicate the presentation quality information for the video encoding.

19. The wireless communication device of claim 18 wherein the processing system is configured to display the video presentation activator comprising indicating that the video presentation will occur without skipping or pausing after presentation of the identified video begins.

20. The wireless communication device of claim 11 wherein the processing system is configured to process wireless network performance data comprising monitoring the performance and resources of a wireless access network.
